(19) United States
(12) Patent Application Publication
(10) Pub. No.: US 2016/0299224 A1
(43) Pub. Date: Oct. 13, 2016

(54) ACTIVE RADAR ACTIVATED ANTI-COLLISION APPARATUS

(71) Applicant: Alexis Stobbe, Oxford, MS (US)

(72) Inventor: Alexis Stobbe, Oxford, MS (US)

(21) Appl. No.: 14/680,985

(22) Filed: Apr. 7, 2015

(51) Int. Cl. G01S 13/93; B60Q 5/00; B60Q 9/00; H01Q 15/14; G01S 7/02

(52) U.S. Cl. CPC G01S 13/931; H01Q 15/14; G01S 7/02; B60Q 9/008; B60Q 5/006; G01S 2007/027

(57) ABSTRACT

The apparatus of the present invention provides onboard detection systems such as automotive radars the ability to react to difficult aspect ratio targets at an off angle to the road greatly increasing the ability of the operator of a vehicle to avoid a collision. The apparatus of the present invention is co-located with the difficult aspect ratio target, either as a mounted device or as an item worn by a person. The apparatus of the present invention is active in that when an incoming radar signal impinges on the apparatus a return signal is sent that contains information identifying the target thereby eliminating the problem of signal ambiguity. Advantageously, the apparatus of the present invention can be adapted to a number of mounting schemes. Examples include mounting the apparatus to the frame of a bicycle, the fender of a motorized mobility device, imbedded into a motorized mobility device, imbedded into a wearable electronic device or attached to the clothing of a cyclist or pedestrian.

### BRIEF DESCRIPTION

The subject of this application relates to detection and prevention of collisions between vehicles of significantly differing size. Specifically, the apparatus of the present invention provides an active radar-activated apparatus that greatly enhances the return signal generated by a small aspect ratio target, for example, a cyclist on the side of a road, thereby warning the operator of an approaching motor vehicle of the presence of the cyclist.

### BACKGROUND OF THE INVENTION

Vehicles of many sizes make use of the roads and highways, including a range from the smallest, low-profile recumbent bicycles to the largest semi-tractor/trailer rigs. In addition, modern vehicles and roads allow for a relatively large difference in speed between these vehicles. For example, a physically impaired person operating a mobility device such as a motorized wheelchair has a top speed of less than ten miles per hour, while an approaching car may be travelling at greater than fifty miles an hour. The difference in speed and visibility of these vehicles sets the stage for a serious problem as a result of the rapid closing speed and the difficulty of the approaching vehicle's operator in seeing the smaller vehicle.

As the speed of vehicles has increased and the roads travelled by all vehicles have improved, technology has stepped in to help alleviate the problem. Many of today's modern roads have dedicated lanes for smaller slower vehicles such as bike lanes and HOV [High Occupancy Vehicle] lanes. While such improvements have helped, since there is no physical barrier to prevent a collision, the problem basically remains. Additionally, many roads do not have such lanes, and in fact have little or no shoulder, thus the smaller vehicle is still dangerously exposed.

Also aiding to the solution of this problem has been the development of on-board automotive warning systems such as sonar, infrared, optical and radar sensing devices. One or more of these devices mounted in an approaching vehicle can serve to warn the operator of that vehicle that they are rapidly closing on a target, thus providing an opportunity to avoid a collision. Hampering these systems and devices are a number of factors including directional sensitivity, signal strength, difficult target aspect ratio and level of integration. Perhaps the most deleterious factor affecting contemporary warning systems is signal ambiguity.

Directional sensitivity in many of the on-board systems is such that only signals directly in front of, or at a narrow side viewing angle to the vehicle are targeted, leaving a vehicles on the side of the road outside the narrow viewing angle undetected. Signal strength is a problem since the radar return is predicated on the size of the painted target, thus a smaller vehicle, for example a cyclist, may not return a signal of sufficient amplitude to trigger an alarm. Difficult target aspect ratio refers to not only the size of a target, but its geometry as well, thus while a given radar might “see” a target that is three feet by three feet it may not see a target that is two feet by four feet. Signal ambiguity occurs when the transmitted signal is reflected off of multiple objects in relatively close proximity and can be exacerbated by sub-optimal weather conditions such as snow or rain. For example, as a motor vehicle in front of the signal transmitting vehicle is approached, if the vehicle in front is close to or beside a small aspect ratio target such as a cyclist, the warning system may see the vehicle in front but not the cyclist.

Finally, level of integration leaves control of the vehicle in the operator's hands for the most part. While some newer systems take over control to provide rapid controlled anti-collision response, this higher level of integration is by no means standard. As a result of this low level of integration, while the onboard system may provide a warning, if the driver remains unaware or unable to control their vehicle a collision is likely.

Added to the above issues is the fact that at this time only higher end vehicles are equipped with anti-collision devices capable of detecting a target. Even fewer have systems integrated to the extent that they will not only detect a target, but will react to that target in a meaningful way in order to avoid a collision. Until these devices and related control mechanisms are in place in all vehicles the problem of detection and avoidance of smaller, difficult aspect ratio targets will persist. Assuming that these devices and control mechanisms will be available in most vehicles in the near to mid-term future, what would be desirable would be an apparatus that allows such devices to detect and react to a difficult aspect ratio target such as a cyclist or a disabled person in a wheelchair. What would be further desirable would be a device that could be used in a broad variety of situations including detection of off axis targets.

### SUMMARY OF THE INVENTION

The apparatus of the present invention provides onboard detection systems such as automotive radars the ability to react to difficult aspect ratio targets at an off angle to the road greatly increasing the ability of the operator of a vehicle to avoid a collision. The apparatus of the present invention is co-located with the difficult aspect ratio target, either as a mounted device or as an item worn by a person. The apparatus of the present invention is active in that when an incoming radar signal impinges on the apparatus a return signal is sent that contains information identifying the target thereby eliminating the problem of signal ambiguity. Advantageously, the apparatus of the present invention can be adapted to a number of mounting schemes. Examples include mounting the apparatus to the frame of a bicycle, the fender of a motorized mobility device, imbedded into a motorized mobility device, imbedded into a wearable electronic device or attached to the clothing of a cyclist or pedestrian.

The present invention is comprised of an electronic subsystem and a mounting means. These two elements are formed such that the apparatus may be mounted to a vehicle, for example the frame of a bicycle or the back of the seat of a mobility device, or imbedded into a motorized device's instruments or worn on a person, for example, attached to the jersey of a bicycle rider or to a backpack of a walker or imbedded into an wearable electronic device such as a watch or integrated into a shoe. In all cases the electronic subassembly is oriented such that its receiving surface is directed rearward toward an oncoming vehicle.

The electronic subassembly is comprised of a millimeter receiving antenna, a radar reflective surface, a circuit board and a weatherproof housing. The mounting means for the apparatus is integrated into the housing forming a single, easy to manage device. The circuit board of the apparatus contains the necessary circuitry to receive, detect, analyze and transmit data associated with millimeter radars used in automotive applications. The process functions associated with the various circuits are accomplished using memory contained within the apparatus.

The rearward facing surface of the apparatus is comprised of a radar-reflective material that augments the signal received from the approaching vehicle, improving the ability of the vehicle's onboard system to detect the target. Within the area of the radar-reflective material is an antenna tuned to the millimeter wavelength of contemporary automotive radar devices. Advantageously, the same antenna is used to both receive and transmit saving cost and complexity.

In operation the apparatus remains inactive until an impinging millimeter radar signal from an approaching vehicle is detected. The signal is analyzed by the electronic circuits and, after fetching identifying data from memory, the apparatus transmits a signal back to the approaching vehicle. Depending on the system in the approaching vehicle, one or both of two actions is taken. The driver of the approaching vehicle, at a minimum, is given a warning identifying the target as a cyclist or some other difficult aspect ratio object. If the approaching vehicle has an advanced control mechanism, as well as the warning, the control system analyzes speed, distance and approach angle data and, if required, takes the appropriate action, for example, automatically applying braking effort to slow the vehicle.

The present invention is discussed in detail below in conjunction with the drawings listed below. As will be evident, the apparatus of the present invention overcomes the disadvantages of the prior art and provides a significant improvement in the likelihood of collision avoidance.

### BRIEF DESCRIPTION OF THE DRAWINGS

FIG. 1: provides a graphical discussion of the problem to be solved.

FIG. 2A: shows the apparatus of the present invention in a first mounting configuration.

FIG. 2B: shows the apparatus of the present invention in a second mounting configuration.

FIG. 3: provides an exploded view of the electronic subassembly of the apparatus of the present invention.

FIG. 4: provides a graphical discussion of the operation of the apparatus of the present invention.

FIG. 5: shows a block diagram of the electronic subassembly of the apparatus of the present invention.

FIG. 6A: provides an overall flowchart describing the process of the present invention.

FIG. 6B: provides a flowchart of the initialization subroutine of the process of the present invention.

FIG. 6C: provides a flowchart of the detection subroutine of the process of the present invention.

### DETAILED DESCRIPTION OF PREFERRED EMBODIMENTS

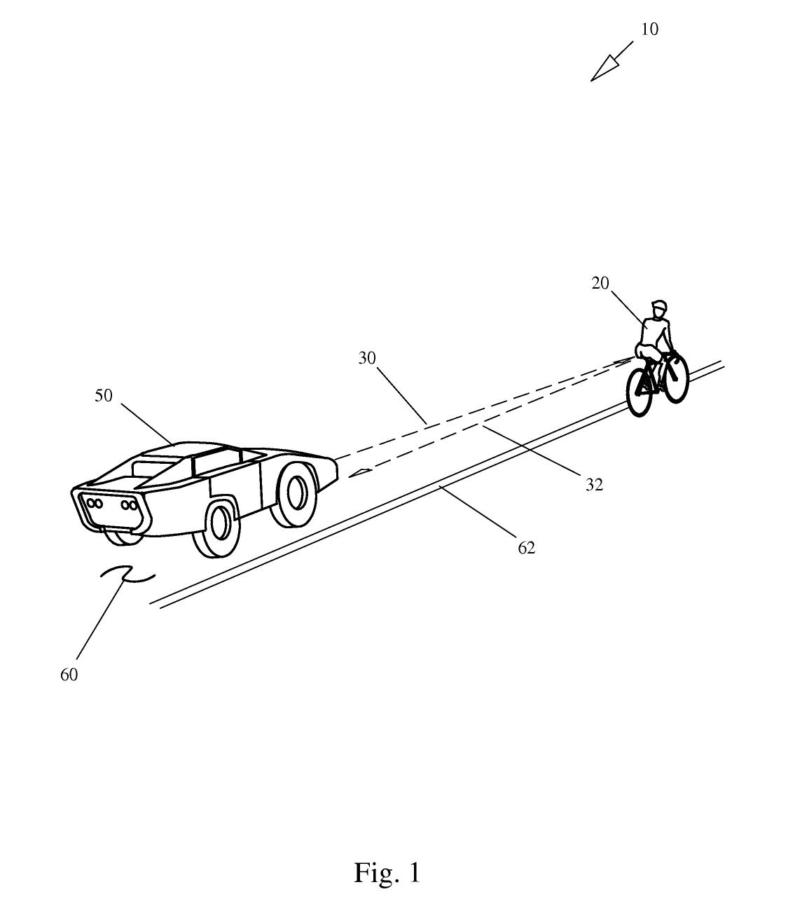

As described briefly above, the apparatus of the present invention significantly improves the likelihood of collision avoidance between a larger vehicle and a difficult aspect ratio target at an off angle to the vehicle. FIG. 1 provides a graphical discussion 10 of the problem to be solved. A vehicle 50 travelling on a road surface 60 is approaching a difficult aspect ratio target 20 from the rear. In this instance the target is a cyclist, but other difficult aspect ratio targets would include pedestrians, motorized mobility devices and others.

As can be seen the cyclist 20 is moving in the same direction as the vehicle 50 on the shoulder of road surface 60, separated only by lane marker 62, thus is unable to see the vehicle approaching. Supposing the vehicle 50 is of a recent vintage and has some form of collision detection capability, for example a millimeter wave radar, an outgoing signal 30 strikes the cyclist 20. A return signal 32 is sent back to the detection device. However, due to the off angle of the target and the small size—or difficult aspect ratio—of the target, the detection device may or may not advise the operator of the vehicle 50 that the target is present on the side of the road.

Depending on the specific type of onboard collision avoidance system vehicle 50 is equipped with, as the vehicle 50 gets closer and closer to cyclist 20 the viewing angle of the transmitted signal becomes greater and greater, and, at some point the onboard system's signal will miss the cyclist 20 completely. If the operator of vehicle 50 has not been made aware of the presence of the cyclist 20 a collision is possible.

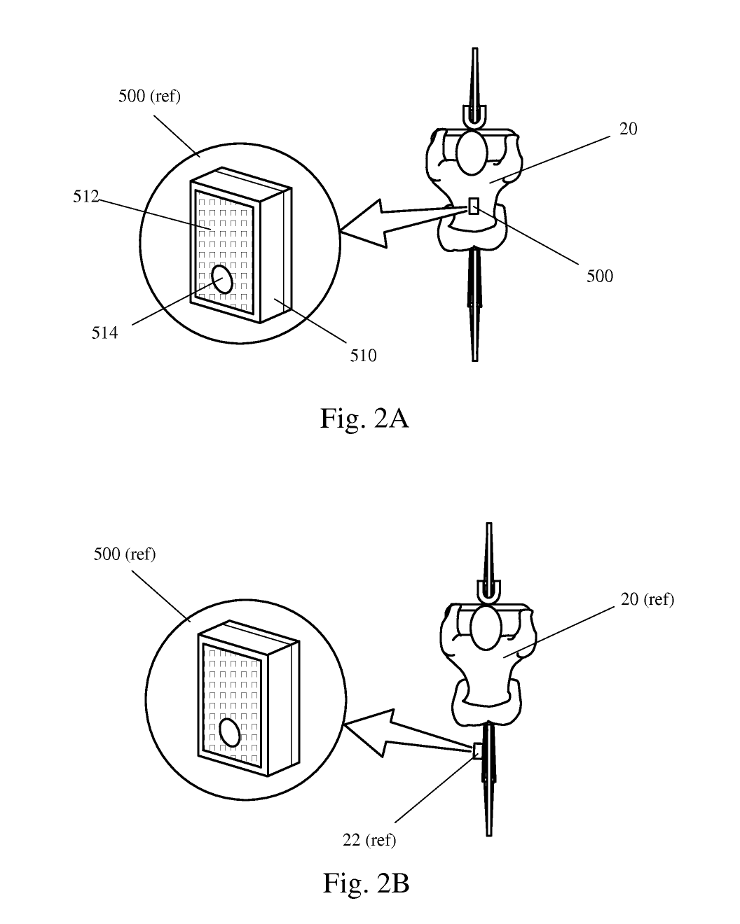

Turning now to FIG. 2, two mounting means for the apparatus of the present invention are shown. In FIG. 2A, a cyclist 20 has clipped/integrated the electronic subassembly 500 to the back of his/her jersey or other accessories. Looking at the expanded view in FIG. 2A, the electronic subassembly can be seen to have a housing 510. The housing 510 has the mounting means affixed to the unseen side, but it will be understood by those of skill in the art that such mounting means exist. The mounting means could be a spring loaded clip, a belt loop clip or some other attachment means suitable for attachment to clothing or could be fully integrated into other cycling devices such as a saddle, cycling computer, GPS, watch or wearable electronic device.

Also shown in the expanded view of FIG. 2A is a radar-reflective surface 512 and an antenna port 514. The purpose of the radar-reflective surface 512 is to augment the apparatus by enhancing the strength of the incoming signal returned to the approaching vehicle's radar. Having this radar-reflective surface allows less sensitive automotive radars to receive a signal sufficient to trigger a warning, and also covers the situation where the transmitting vehicle is not advanced enough to receive and analyze target information data sent by the apparatus of the present invention.

Antenna port 514 allows impinging radar signals to be received by the apparatus of the present invention. Located behind antenna port 514 is a millimeter wavelength antenna capable of receiving contemporary automotive radar signals. Of importance is that the antenna (not shown) is used as both the receiving and transmitting antenna, thus simplifying the electronic subassembly. While the antenna is not shown or described in detail, those of skill in the art will recognize that such antennas exist and that the antenna in the instant application will operate in the conventional manner.

FIG. 2B shows the electronic subassembly 500 of the present invention in an alternative mounting configuration. Here, the apparatus has been attached to the frame of a bicycle, for example, the left side seat stay. It will be understood by those skilled in the art that the apparatus could just as easily be mounted to the rear side of the seat of a mobility device, or to any other surface that allows the electronic subassembly 500 to face rearward, thus the use of a jersey as in FIG. 2A or the seat stay as in FIG. 2B is not meant as a limitation on the scope of the invention.

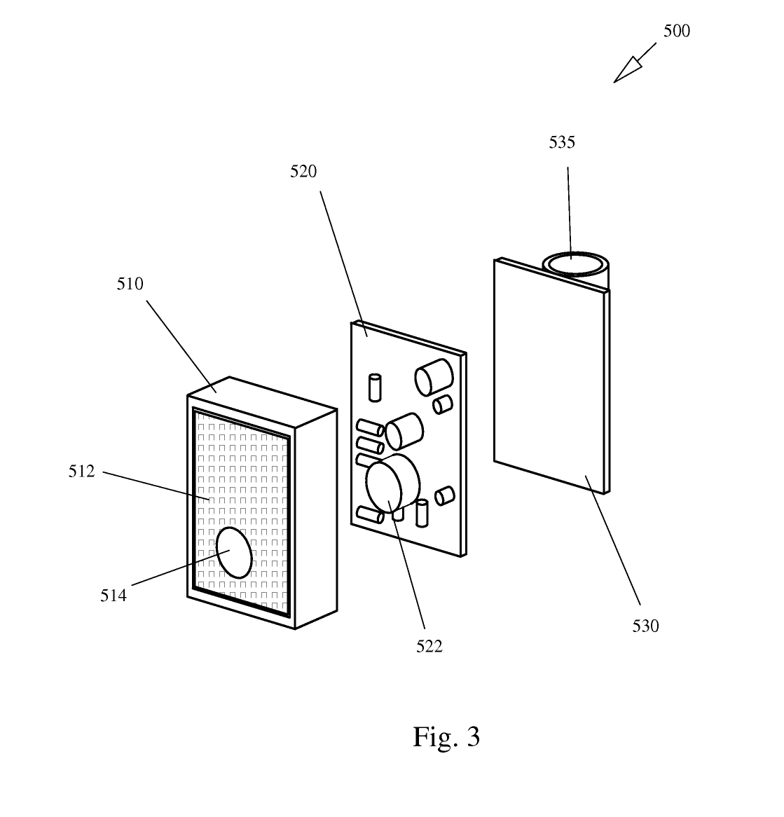

FIG. 3 provides an exploded view of the major components of the electronic subassembly 500. A housing 510 serves as a cover for the circuit board 520 as well as the mounting surface for the radar reflector 512 and millimeter antenna window 514. The radar reflector 512 serves to enhance the return signal of an impinging radar wave signal, thus aiding in the detection of the apparatus by an automotive radar in an approaching vehicle. The millimeter antenna window 514 allows the impinging radar signal to pass through the housing 510 unimpeded allowing it to strike the millimeter radar antenna 522 mounted to the circuit board 520.

In a preferred embodiment of the present invention the housing 510 is made from plastic and is two inches wide by three inches high by 0.75 inches deep; however, it will be understood by those of skill in the art that other materials, for example aluminum, could be used without departing from the spirit of the invention, thus the use of plastic is exemplary only. The radar reflector 512 is also made from plastic, but has a plurality of concave dimples covered by a metallic coating. The dimples are 1.95 mm in diameter and 0.97 mm deep to provide maximum reflection at 77 GHz which is the current frequency for automotive radar systems. It will be understood that other dimple dimensions could be used without departing from the spirit of the invention in order to accommodate other radar frequencies. For example, as automotive radar migrates to the 79 GHz frequency the dimple dimensions could be downsized slightly to improve the reflectivity of the higher frequency.

The millimeter antenna window 514 in a preferred embodiment is made from clear acrylic. As well as allowing incoming and outgoing radar signals to pass, the millimeter antenna widow 514 keeps external matter such as dust and water from entering the housing.

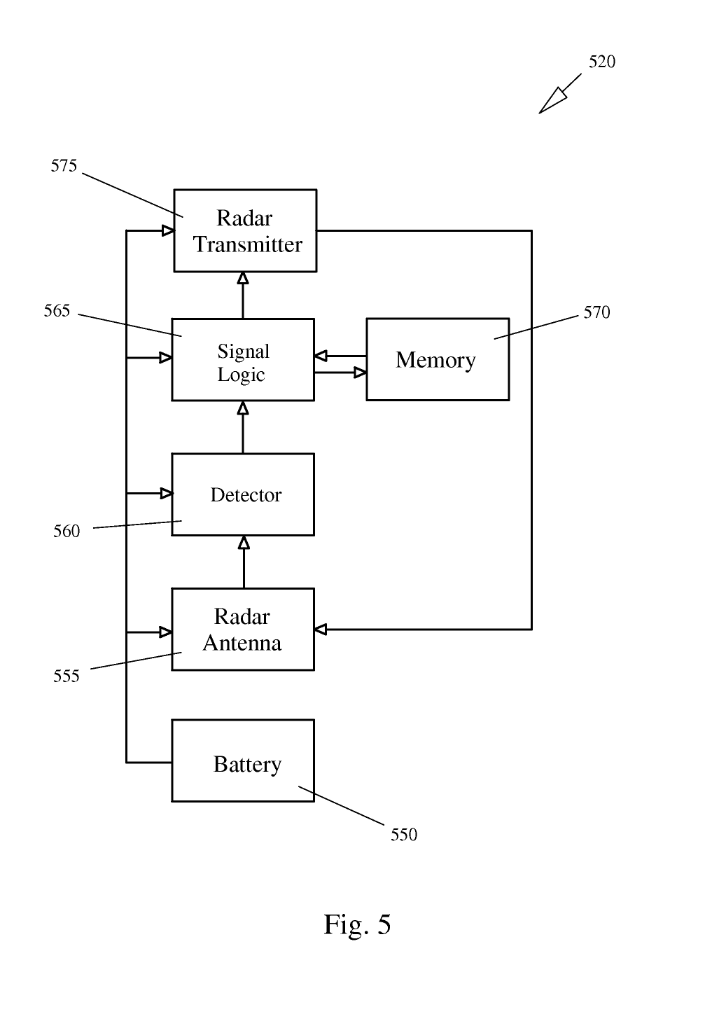

Circuit board 520 contains all the electronic componentry required to detect, analyze and respond to an incoming radar signal. As discussed in detail in conjunction with FIG. 5, this includes the millimeter antenna 522, a memory, integrated circuit logic and all supporting discrete components normally associated with an electronics subassembly. In a preferred embodiment the millimeter antenna 522 is of the planar type such as those used in contemporary automotive applications. The integrated circuits logic in a preferred embodiment is based upon a bit slice processor, but as will be recognized by those of skill in the art, other forms of logic, for example, a fully integrated circuit containing all the functions could be used.

Mounting plate 530 serves two distinct purposes. First, it is the surface to which the circuit board 520 and the housing 510 are mounted. Housing 510 mates with mounting plate 530 in such a way as to make it impervious to weather conditions such as rain, dirt and blowing objects stirring about due to passing vehicles or wind. Second, mounting plate 530 has attachment means 535 fixably placed on its rear surface. The attachment means 535 may take any one of a number of physical implementations such as a spring loaded clamp, hook-and-loop methods such as Velcro [Velcro Industries BV, Amsterdam, Holland], or a belt loop, thus the spring clamp means shown is presented as exemplary only and is not meant as a limitation on the scope of the invention. In a preferred embodiment of the present invention the mounting plate 530 is made from plastic, but it will be understood by those of skill in the art that other materials, for example aluminum, could be used without departing from the spirit of the invention, thus the use of plastic is exemplary only.

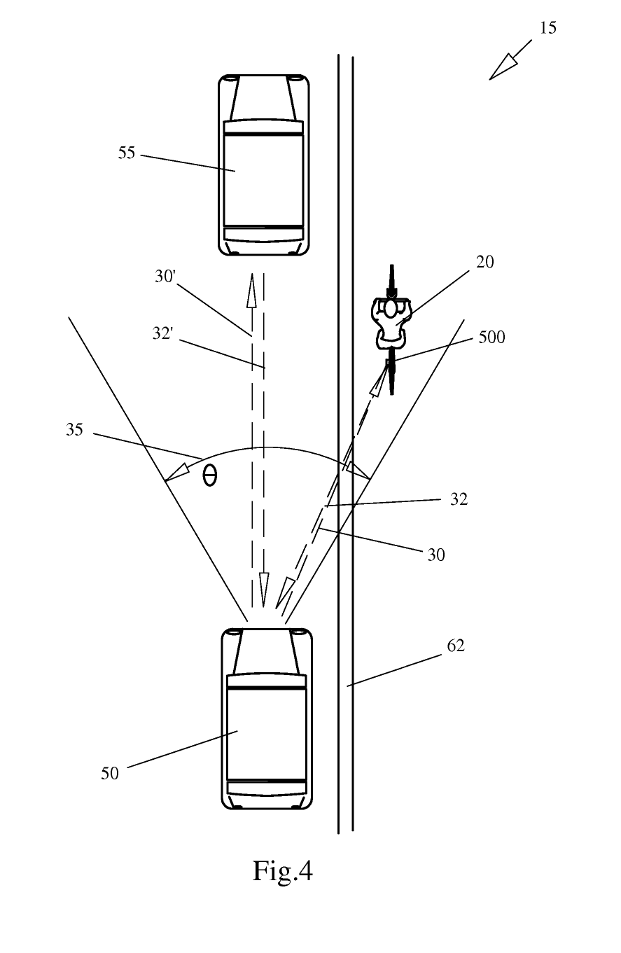

Looking at FIG. 4, an overview 15 of the application of the present invention is shown in detail. A vehicle 50 is equipped with a radar device and is transmitting normally, emitting a millimeter radar signal across transmitting angle theta 35. A cyclist 20 is riding on the shoulder outside of the road separator 62, travelling in the same direction as the vehicle 50, thus is unable to see the vehicle 50. Also travelling in the same direction ahead of vehicle 50 is a second vehicle 55. Note that at some point the leading vehicle 55 will be directly abreast of cyclist 20 as following vehicle 50 is approaching. The practical implication here is that the leading vehicle 55 presents a far larger target than cyclist 20, meaning that the return signal 32 from cyclist 20 will likely be swamped by the return signal 32′ from leading vehicle 55.

The radar device in the following vehicle 50 is constantly transmitting and receiving signals. Outgoing signals 30 and 30′ strike their respective targets 20 and 55, returning signals 32 and 32′ in the conventional manner. As long as the leading vehicle 55 is not in relatively close proximity to cyclist 20 the operator of the vehicle 50 may be advised of the presence of the cyclist 20. If, as noted above, the second vehicle 55 is beside or slightly in front of cyclist 20, the return signal from the cyclist 20 will be swamped by the strength of the signal from the second vehicle 55.

Suppose now that the cyclist 20 has the apparatus 500 of the present invention mounted to the seat stay of his/her bicycle. When the incoming radar signal 30 from the following vehicle 50 impinges on the apparatus 500 of the present invention, the reflected return signal 32 appears to the radar device as a substantially larger target. This is true for two reasons. First, the radar reflective surface [512 of FIG. 3] enhances the return signal 32 in a passive manner. Second, a separate return signal is sent from the apparatus 500 containing information about the target. This information, described in greater detail below in conjunction with FIG. 5, is processed by the control mechanism in the following vehicle 50, doing one or both of issuing a warning and/or applying some control over the vehicle itself. Thus even if the leading vehicle 55 is directly alongside the cyclist 20, the operator of the following vehicle 50 will be warned of a target ahead. In this way the apparatus of the present invention substantially increases the likelihood that the operator of vehicle 50 will be able to avoid a collision.

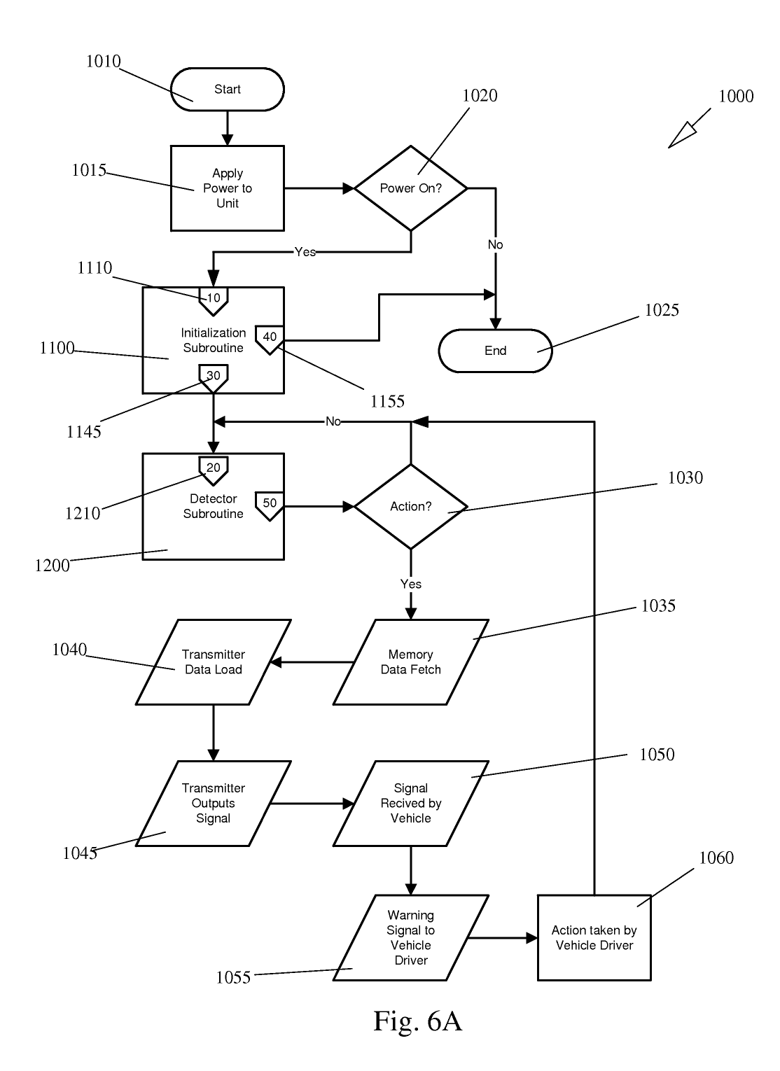

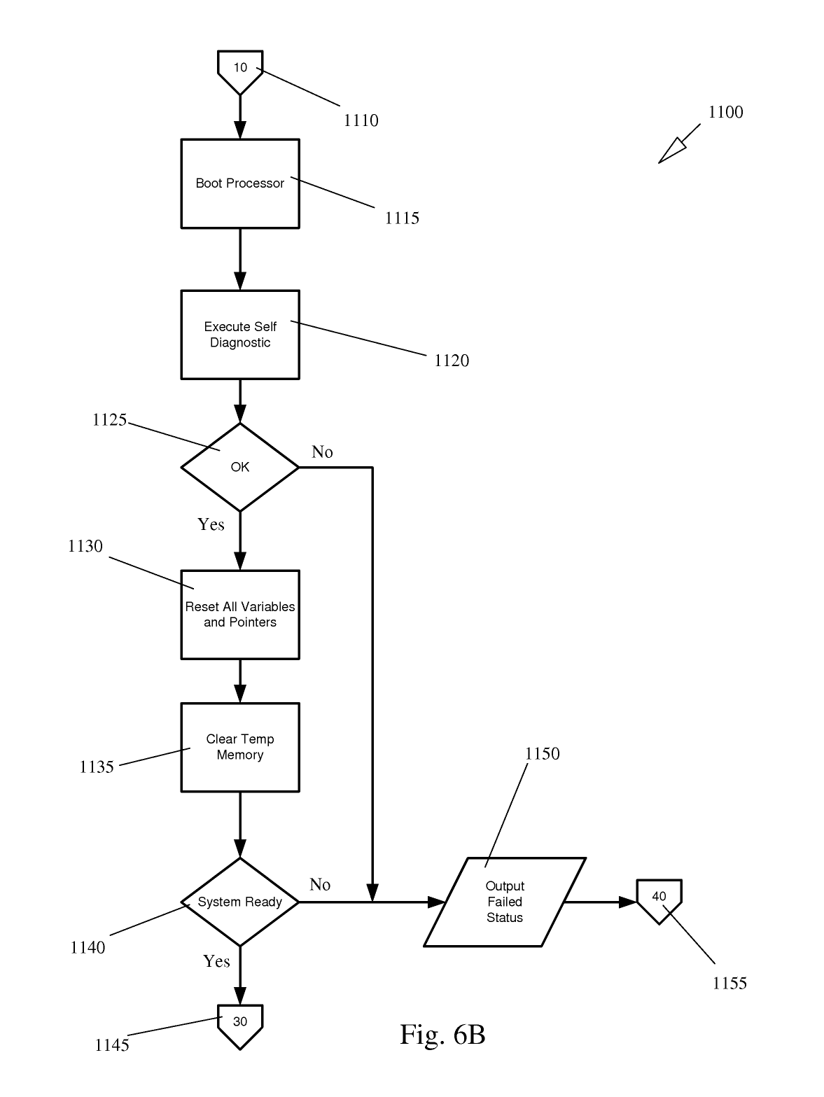

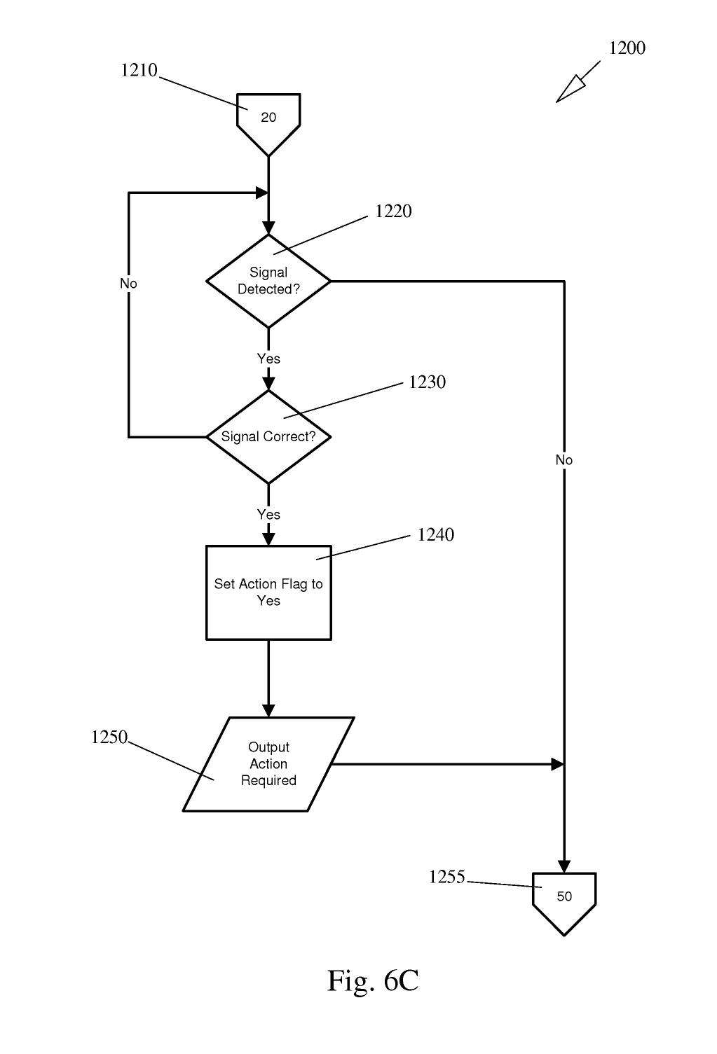

Turning now to FIG. 5, a block diagram 520 of the electronic subassembly of the present invention is shown. A battery 550 provides power to all sub-circuits that comprise the electronic subassembly 520. A millimeter radar antenna 555, capable of both receiving and transmitting millimeter wavelength radar signals, is coupled to a detector 560. The detector 560 interfaces with the signal logic block 565. While the exact details of the signal logic block 565 are not shown, it will be understood by those of skill in the art that such logic exists and that this instance of such logic operates in a conventional manner. The details of the operation of signal logic block 565 are presented below in conjunction with the discussion of FIGS. 6A through 6C.

Signal logic block 565 interfaces with a memory 570 and the radar transmitter 575. Memory 570 contains all the data and programs needed to operate the apparatus of the present invention. FIG. 6 discusses the program flow and will be presented later. The data in memory 570 includes program control data and information about the particular target. In the instant case this means that the data that is transmitted back to an approaching vehicle will identify the target as a cyclist. However, it will be understood that other data, for example, data identifying the target as a pedestrian or a person in a mobility device can be substituted without departing from the spirit of the invention, thus the scope of the invention is limited only by the claims.

Radar transmitter 575 interfaces with signal logic 565. The output of radar transmitter 575 is fed to radar antenna 555 which then broadcasts the return signal containing the data relevant to the apparatus back to the approaching vehicle. It will be understood that the antenna 555 can operate as both a receiving and transmitting antenna and that the signal logic 565 controls a switch [not shown] to properly configure the antenna 555 as is well known in the art.

FIG. 6 provides a flow chart discussion 1000 of the process of the present invention. The process begins at the Start terminator 1010. Process step 1015 applies power to apparatus, for example, when a user closes a power switch. At decision step Power On 1020 the determination as to whether or not power is present is made. If the apparatus is off no power is present and process flow moves to the Stop terminator 1025 where the process terminates. If power has been applied, the Yes path is followed leading to the Initialization Subroutine step 1100.

FIG. 6B provides the details of the initialization subroutine 1100. The initialization subroutine 1100 is entered at step 1110 via off page connector 10. At the boot processor step 1115 the signal logic [565 of FIG. 5] initializes and an internal diagnostic is run at execute self-diagnostic step 1120 to determine the status of the circuitry. If an error occurs which will disallow the apparatus of the present invention to perform its functions at ok step 1125 the No path is followed to the output failed status step 1150. If the status of the circuitry is determined to be proper the Yes path is followed out of the ok step 1125 to the reset all variables step 1130.

At reset all variables and pointers step 1130 all program variables are reset in preparation for normal operation. While not intended as a limitation, examples of such variables would be timers, event counters, memory stack pointers, signal values and other flags used in contemporary program implementation. At clear temp memory step 1135 any previous values stored in temporary memory locations are set to zero.

Process flow now passes to the system ready step 1140. If the process was unable to place the apparatus in a state capable of performing its function, the no path is followed out of system ready step 1140 to the output failed status step 1150. From the output failed status step 1150 process flow moves to the end step 1025 of FIG. 6A via off page connector 1155 and the process stops. If the apparatus of the present invention is in a state that makes it capable of performing its function the yes path is followed out of system ready step 1140, returning to the main process flow of FIG. 6A via off page connector 30 at step 1145.

Returning briefly to FIG. 6A, process flow moves from the initialization subroutine 1100 to the detector subroutine 1200 via off page connector 20. FIG. 6C shows that the detector subroutine 1200 is entered at step 1210 via off page connector 20. If no incoming radar signal is detected at signal detected step 1220 the process returns to the action step 1030 of FIG. 6A via off page connector 50. If an incoming radar signal is detected, process flow passes to the signal correct decision 1230 to determine if the incoming signal is of the proper type. This is done to prevent the apparatus from reacting to random signals.

If the incoming signal does not have the proper automotive radar characteristics the no path is followed out of signal correct step 1230, returning to the signal detected step 1220. The process will loop through these two steps until a radar signal having the proper characteristics is detected. When this occurs, the yes path is followed out of signal correct step 1230 and the process enters the set action flag to yes step 1240. At this time the process has determined that a proper radar signal has been detected, meaning that a vehicle is approaching the apparatus. Process flow now moves to the output action required step 1250, passing a logical signal to take appropriate action back to the main flow in FIG. 6A via off page connector 50 at step 1255.

At the action step 1030 the process flow has returned from the detector subroutine 1200 via off page connector 50. There are two possible reasons for the flow to return to the action step 1030; either a proper signal has been detected or no signal at all has been detected. If no signal has been detected the no path is followed out of action step 1030, returning process flow to the input of the detector subroutine 1200. The process will execute this loop until a proper incoming signal has been detected.

If a proper radar signal has been detected the process follows the yes path out of action step 1030 moving to the memory data fetch step 1035. At memory data step 1035 the process accesses the memory of the apparatus, sending data appropriate for the user of the apparatus. For example, if the apparatus is being used by a cyclist, the data sent to the transmitter for broadcast to the approaching vehicle will contain information indicating that there is a target ahead and that it is a cyclist.

It will be noted that while no specific details of the programming of the data are provided, those of skill in the art will understand that contemporary methods for programming data into a memory and retrieving that data are common, thus the details of that part of the process are not present to aid in clarity. The absence of such a detailed explanation should not be read as a limitation on the scope of the invention.

At transmitter data load step 1040 the appropriate data that have been fetched from memory are loaded into the transmitter. At transmitter outputs data step 1045 the apparatus sets the transmit/receive switch to transmit and outputs a signal containing that data to the approaching vehicle. The approaching vehicle receives the data sent by the apparatus of the present invention at the signal received by vehicle step 1050. At warning signal to vehicle driver step 1055 the driver of the vehicle is provided with a warning and, at the same time, the apparatus of the present invention sends a warning signal to the cyclist. In a preferred embodiment this warning is in the form of an audio burst, but as will be recognized by those of skill in the art, other warnings, or combinations thereof, could be used, for example, a flashing light. At action taken by vehicle driver step 1060 the driver of the approaching vehicle takes whatever action is needed and the process and process flow returns to the input to the detector subroutine 1200. The process will continue to execute this loop until power from the apparatus has been removed.

As can been seen from the detailed discussion above, the various aspects of the present invention represent a significant advance in the state of the anti-collision arts. Specifically, the combination of the apparatus and the process of the present invention allows for a warning to be provided to both the operator of a vehicle approaching a small aspect ratio target from the rear and that small aspect target, even if the target is at an off angle to the vehicle.

One advantage of the present invention is that it is active. An incoming radar signal triggers a process that not only returns an enhanced radar signature, but also passes data specific to the target enabling more refined processing by an approaching vehicle. The embedded data returned to the transmitting radar effectively eliminates the problem of signal ambiguity.

A second advantage of the present invention is that it significantly increases the ability of a properly equipped vehicle to detect a difficult aspect ratio target and thus avoid a collision, even in the presence of a larger radar target. Moreover, due to the construction of the apparatus, the viewing angle of the approaching vehicles radar is increased, allowing continued detection closer to the user of the apparatus.

A third advantage of the present invention is that it is adaptable to a wide variety of difficult aspect ratio targets including pedestrians, cyclists and users of mobility devices. A flexible mounting means is provides so that the apparatus of the present invention may be attached to a broad range of surfaces.

A fourth advantage of the present invention is that it not only provides a warning to the driver of an approaching vehicle, it also provides the user of the apparatus to be warned. The ability to warn both the driver and the user represents a significant enhancement in the state of the anti-collision arts.

What is claimed is:

1. An apparatus for providing a collision warning to both the operator of a motor vehicle approaching a difficult aspect ratio target at an off angle from the rear and to the operator of that difficult aspect ratio target comprised of:
a housing having a rearward facing surface coated with a radar reflective material, said rearward facing surface having a pattern of concave dimples underlying said radar reflective material, said rearward facing surface further having an antenna opening, said antenna opening having a clear window, said window to prevent foreign material from entering said housing;
a mounting plate for receiving said housing, said mounting plate and said housing forming a weather tight unit, said mounting plate further having a clamping means for attaching said weather tight unit to an object, and;
a circuit board disposed between said mounting plate and said housing, said circuit board fixably attached to said mounting plate, said circuit board further having an antenna for receiving and transmitting radar signals and supporting electronic circuits for executing logical functions required to provide one or more warning signals in response to an impinging signal.

2. The housing of claim 1 wherein the housing is made from plastic and is two inches wide by three inches high by 0.75 inches deep.

3. The rearward facing surface of the housing of claim 1 wherein the dimples are 1.95 mm in diameter and 0.97 mm deep.

4. The rearward facing surface of claim 1 wherein the radar reflective material is an aluminum coating.

5. The mounting plate of claim 1 wherein the clamping means is a spring loaded clip, said spring loaded clip capable of firmly attaching the apparatus to the chain stay of a bicycle.

6. The mounting plate of claim 1 wherein the clamping means is comprised of a hook and loop fastener, said clamping means having the hook portion of said hook and loop fastener fixably attached to the outer surface of said mounting plate and the loop portion of said hook and loop fastener fixably attached to an object.

7. The mounting plate of claim 1 wherein the clamping means is a spring loaded clip, said spring loaded clip capable of firmly attaching the apparatus to the clothing of a person.

8. The circuit board of claim 1 wherein said circuit board is configured to receive, analyze and transmit radar signals in the 77 GHz frequency range.

9. A method for providing a collision warning to both the operator of a motor vehicle approaching a difficult aspect ratio target at an off angle from the rear and to the operator of that difficult aspect ratio target comprised of:
applying power to an apparatus configured to receive, analyze and transmit radar signals;
initializing said apparatus, said initializing further comprised of;
executing a self-diagnostic test;
resetting all process variables;
clearing all temporary memory data;
outputting a system ready status;
detecting an incoming radar signal from an approaching vehicle, said detecting further comprised of;
determining if the incoming signal is correct;
setting an action flag in temporary memory;
outputting an action required status;
fetching data related to the user of the apparatus from permanent memory;
loading said data related to the user of the apparatus to a transmitter;
sending a return radar signal to said approaching vehicle, said vehicle then issuing a warning to the operator of said vehicle, and;
issuing a warning to the user of said apparatus.

10. The issuing a warning to the user of the apparatus wherein the warning consists of one or more of an audio signal, visual signal or combination of said audio and said visual signals.
